(19) United States
(12) Patent Application Publication
(10) Pub. No.: US 2026/0331751 A1
(43) Pub. Date: Oct. 22, 2026

(54) IMAGE FORMING APPARATUS

(71) Applicant: KYOCERA Document Solutions Inc., Osaka (JP)

(72) Inventors: Shizuya Uemura, Osaka (JP); Tomoyuki Kitao, Osaka (JP)

(21) Appl. No.: 19/642,582

(22) Filed: Apr. 8, 2026

(30) Foreign Application Priority Data
Apr. 18, 2025 (JP) 2025-068925

(51) Int. Cl. H01Q 1/22; H01Q 7/00

(52) U.S. Cl. CPC H01Q 1/2216; H01Q 7/00

(57) ABSTRACT

An image forming apparatus includes a wireless tag of a part detachable from/to this image forming apparatus, and a main-body-side antenna. The main-body-side antenna is configured to communicate with the wireless tag. Further, the wireless tag includes an antenna in parallel with a mounting direction of the part. The main-body-side antenna has a width larger by a predetermined width than a width of the antenna in the mounting direction of the part. The predetermined width is an allowable width of a mounting position of the part, and the allowable width corresponds to a tolerance of mechanical detachable mechanism of the part.

### CROSS-REFERENCE TO RELATED APPLICATIONS

This application relates to and claims priority rights from Japanese Patent Application No. 2025-068925, filed on Apr. 18, 2025, the entire disclosures of which are hereby incorporated by reference herein.

### BACKGROUND

### 1. Field of the Present Disclosure

The present disclosure relates to an image forming apparatus.

### 2. Description of the Related Art

An image forming apparatus includes an antenna capable of communication with an RFID tag in a detachable ink tank unit, and reads identification information from the RFID tag using the antenna.

FIG. 3 shows a top-view diagram that indicates an example of a configuration of an ordinary image forming apparatus. As shown in FIG. 3 for example, if a wireless tag 111 of an ink tank unit 101 is fixed on an upper surface of the ink tank unit 101 substantially in parallel with a mounting direction of the ink tank unit 101, then in general, a mechanical design of it is done in consideration of transmission efficiency of a radio wave or a magnetic field between an antenna 111a of the wireless tag 111 and an antenna 121 of a reader/writer 102 side such that (a) a width Wr of the antenna 121 of the reader/writer 102 side agrees with a width Wt of the antenna 111a of the wireless tag 111, and (b) when the ink tank unit 101 is mounted, a position of a center Ct of the antenna 111a of the wireless tag 111 and a position of a center Cr of the antenna 121 of the reader/writer 102 side agree with each other.

However, there is a tolerance in a design of such mechanical detachable mechanism of the ink tank unit 101, and therefore, when the ink tank unit 101 is actually mounted, a position of the center Ct of the antenna 111a of the wireless tag 111 and a position of the center Cr of the antenna 121 of the reader/writer 102 side do not agree with each other in a mounting direction of the ink tank unit 101 and consequently, the transmission efficiency may be decreased between the antenna 111a of the wireless tag 111 and the antenna 121 of the reader/writer 102 side.

This feature may occur on a wireless tag of a part detachable from/to the image forming apparatus other than the ink tank unit 101 as well.

### SUMMARY

An image forming apparatus according to an aspect of the present disclosure includes a wireless tag of a part detachable from/to this image forming apparatus, and a main-body-side antenna. The main-body-side antenna is configured to communicate with the wireless tag. Further, the wireless tag includes an antenna in parallel with a mounting direction of the part. The main-body-side antenna has a width larger by a predetermined width than a width of the antenna in the mounting direction of the part. The predetermined width is an allowable width of a mounting position of the part, the allowable width corresponding to a tolerance of mechanical detachable mechanism of the part.

These and other objects, features and advantages of the present disclosure will become more apparent upon reading of the following detailed description along with the accompanied drawings.

### BRIEF DESCRIPTION OF THE DRAWINGS

FIG. 1 shows a perspective-view diagram that indicates a configuration of an image forming apparatus according to an embodiment of the present disclosure;

FIG. 2 shows a top-view diagram that indicates a configuration of an image forming apparatus according to an embodiment of the present disclosure; and

FIG. 3 shows a top-view diagram that indicates an example of a configuration of an ordinary image forming apparatus.

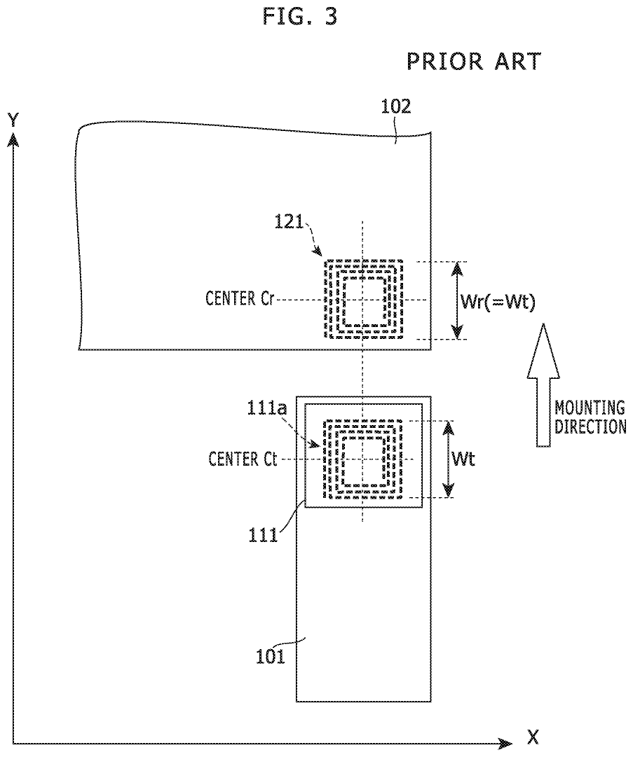

### DETAILED DESCRIPTION

Hereinafter, an embodiment according to an aspect of the present disclosure will be explained with reference to drawings.

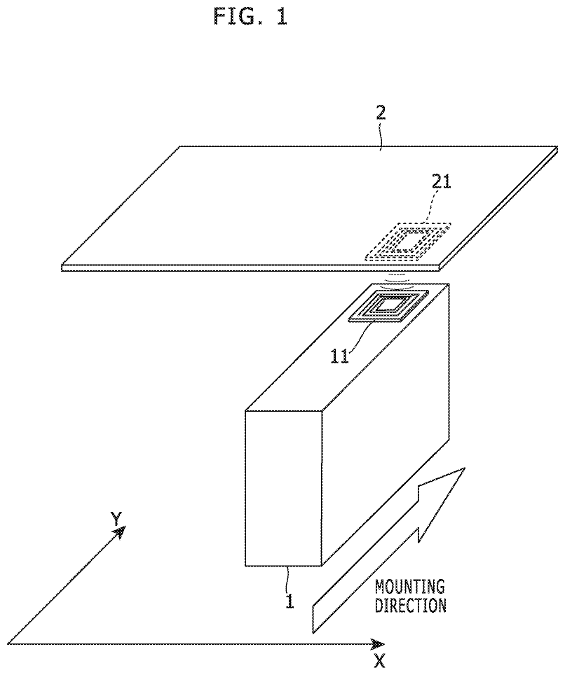

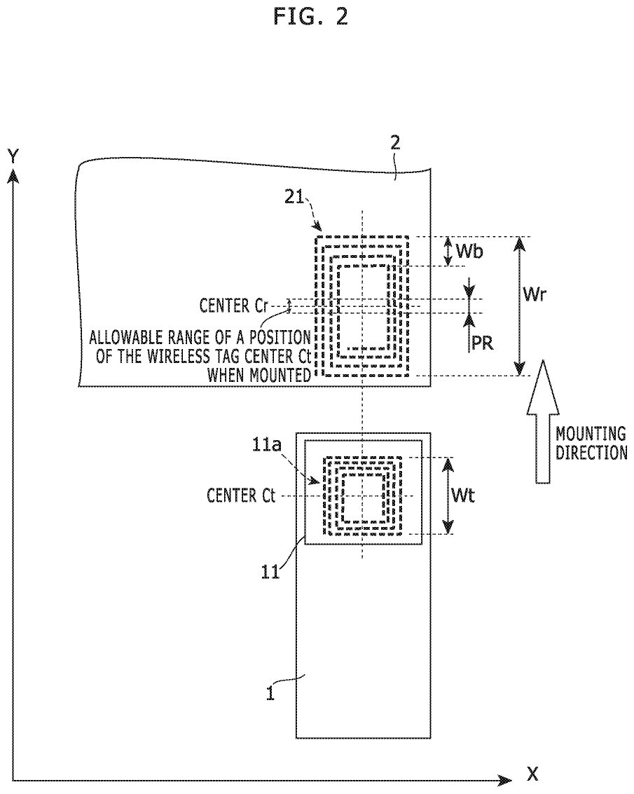

FIG. 1 shows a perspective-view diagram that indicates a configuration of an image forming apparatus according to an embodiment of the present disclosure. FIG. 2 shows a top-view diagram that indicates a configuration of an image forming apparatus according to an embodiment of the present disclosure. The image forming apparatus shown in FIGS. 1 and 2 is an inkjet printer, an inkjet multi function peripheral or the like, for example, and in this image forming apparatus, an ink tank unit 1 is detachable. The ink tank unit 1 has a substantially cuboid shape and contains ink in an internal ink storage unit of it.

The ink tank unit 1 includes a wireless tag 11 (here, RFID). In the wireless tag 11, stored are identification information, property information (Point of Production information, toner counter information, and/or the like) and the like of the ink tank unit 1. Here, in the ink tank unit 1, the wireless tag 11 is fixed on an upper surface of the ink tank unit 1 parallel with a mounting direction (detachable direction) of the ink tank unit 1 (Y axis direction in the figure).

Further, this image forming apparatus includes a main-body-side antenna 21 on a printed wiring board 2. The main-body-side antenna 21 is used for communication with the wireless tag 11 of the mounted ink tank unit 1. The main-body-side antenna 21 may be formed as a printed wiring. The printed wiring board 2 is fixed to an internal structure (frame or the like) of this image forming apparatus such that the main-body-side antenna 21 faces the wireless tag 11 of the mounted ink tank unit 1.

In particular, as shown in FIG. 1 for example, the wireless tag 11 includes an antenna 11a in parallel with a mounting direction of the ink tank unit 1. Further, as shown in FIG. 2 for example, the main-body-side antenna 21 has a width Wr that is larger by a predetermined width PR than a width Wt of the antenna 11a, and the predetermined width PR is an allowable width of a mounting position of the ink tank unit 1 such that the allowable width corresponds to a tolerance of mechanical detachable mechanism of the ink tank unit 1 to a main body of the image forming apparatus.

Furthermore, in this embodiment, the main-body-side antenna 21 and the antenna 11a are loop antennas that have substantially-rectangular shapes, and the wireless tag 11 is a wireless tag for an HF (High Frequency) band (i.e. for a frequency band of shortwaves of which wave lengths are in a range from 10 meters to 100 meters).

Furthermore, in this embodiment, the antenna 11a is a loop antenna that has a substantially-square shape, and the main-body-side antenna 21 is a loop antenna that has a substantially-rectangular shape; and in a perpendicular direction to the mounting direction (X axis direction in the figure), a width of the main-body-side antenna 21 and a width of the antenna 11a are substantially same as each other.

Here, a width Wb of a wiring bunch of the aforementioned loop antenna in the aforementioned mounting direction may be equal to or larger than the aforementioned predetermined width PR and thereby high transmission efficiency of the radio wave or the magnetic field may be kept wherever the mounting position of the ink tank unit 1 is in the aforementioned allowed range.

Here, the image forming apparatus further includes a printing device, a controller, and the like. The printing device performs printing using the ink in the ink tank unit 1. The controller includes a microcomputer, an ASIC (Application Specific Integrated Circuit) and/or the like, causes the printing device to perform printing, and reads and writes data (the aforementioned identification information and/or the property information) from/to the wireless tag 11 of the ink tank unit 1 using the main-body-side antenna 21. This controller may not have an anti-collision function, and may perform communication between the main-body-side antenna 21 and the wireless tag 11 in a one-on-one manner without an anti-collision function and thereby may read/write data.

The following part explains a behavior of the aforementioned image forming apparatus.

When the ink tank unit 1 is mounted to the main body of the image forming apparatus, the center Ct of the antenna 11a of the wireless tag 11 of the ink tank unit 1 is located at any position in the predetermined allowed range PR. At that time, the center Ct of the antenna 11a may be shifted from the center Cr of the main-body-side antenna 21 due to a tolerance of detachable mechanism of the ink tank unit 1.

The controller communicates with the wireless tag 11 of the ink tank unit 1 using the main-body-side antenna 21 and thereby performs reading/writing of the aforementioned data. At that time, a radio wave or a magnetic field is emitted from the main-body-side antenna 21 and sensed by the antenna 11a of the wireless tag 11.

For example, the controller applies a carrier wave of a predetermined intensity to the main-body-side antenna 21 and thereby the carrier wave is emitted from the antenna 21 to the wireless tag 11. Further, the wireless tag 11 changes an impedance of the antenna 11a correspondingly to data to be transmitted and changes a reflection intensity, and thereby emits a modulated wave. Further, the main-body-side antenna 21 senses the modulated wave from the wireless tag 11, and the controller acquires data from the wireless tag 11 on the basis of the modulated wave.

Here, even if the center Ct of the antenna 11a of the wireless tag 11 is shifted from the center Cr of the main-body-side antenna 21 in the allowed range, the transmission efficiency of the radio wave or the magnetic field does not easily decrease because the antenna 11a of the wireless tag 11 falls in a range of the main-body-side antenna 21 (i.e. within the width Wr).

As mentioned, in the aforementioned embodiment, the main-body-side antenna 21 communicates with the wireless tag 11 of the mounted ink tank unit 1 detachable to the image forming apparatus. The wireless tag 11 includes an antenna 11a in parallel with a mounting direction of the ink tank unit 1. The main-body-side antenna 21 has a width that is larger by a predetermined width than a width of the antenna 11a, and the predetermined width is an allowable width of a mounting position of the ink tank unit 1 such that the allowable width corresponds to a tolerance of mechanical detachable mechanism of the ink tank unit 1 to the main body of the image forming apparatus.

Consequently, it is restrained to decrease the transmission efficiency of a radio wave or a magnetic field between the antennas 11a and 21 of the ink tank unit 1 and the main body side due to a tolerance in a detachable mechanism of the detachable ink tank unit 1.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned, the wireless tag 11 may be fixed on a side surface or a bottom surface of the ink tank unit 1 parallel with the mounting direction.

Further, in the embodiment, the ink tank unit 1 is shown as an example of a detachable part, but alternatively, for a detachable part other than the ink tank unit 1, the same configuration of the wireless tag and the main-body-side antenna may be applied. It should be noted that the aforementioned image forming apparatus may be an electrophotographic image forming apparatus, and in such a case, the aforementioned detachable part may be a toner cartridge or the like.

What is claimed is:

1. An image forming apparatus, comprising:
a wireless tag of a part detachable from/to this image forming apparatus; and
a main-body-side antenna configured to communicate with the wireless tag;
wherein the wireless tag comprises an antenna in parallel with a mounting direction of the part;
the main-body-side antenna has a width larger by a predetermined width than a width of the antenna in the mounting direction of the part; and
the predetermined width is an allowable width of a mounting position of the part, the allowable width corresponding to a tolerance of mechanical detachable mechanism of the part.

2. The image forming apparatus according to claim 1, wherein the main-body-side antenna and the antenna are loop antennas that have substantially-rectangular shapes; and
the wireless tag is a wireless tag for an HF band.

3. The image forming apparatus according to claim 1, wherein the antenna is a loop antenna that has a substantially-square shape;
the main-body-side antenna is a loop antenna that has a substantially-rectangular shape; and
in a perpendicular direction to the mounting direction, a width of the main-body-side antenna and a width of the antenna are substantially same as each other.
